(19) United States
(12) Patent Application Publication
(10) Pub. No.: US 2012/0051039 A1
(43) Pub. Date: Mar. 1, 2012

(54) LED TUBE LAMP

(75) Inventor: SHAO-HAN CHANG, Tu-Cheng (TW)

(73) Assignee: HON HAI PRECISION INDUSTRY CO., LTD., Tu-Cheng (TW)

(21) Appl. No.: 13/095,915

(22) Filed: Apr. 28, 2011

(30) Foreign Application Priority Data
Aug. 24, 2010 (CN) 201010261590.5

(51) Int. Cl. F21V 29/00

(52) U.S. Cl. 362/218

(57) ABSTRACT

An LED tube lamp includes a heat sink, an LED substrate, a cover fixed to the heat sink. A light gathering wall arranged between the cover and the LED substrate. The cover further includes a condenser lens, the light gathering wall is configured for reflecting and gathering the light beams emitting from the LEDs, the condenser lens is configured for gathering the light beams reflected from the light gathering wall. The light beams emitting form the LEDs can be controlled substantially in a desired illuminating range after being gathered twice.

### BACKGROUND

1. Technical Field

The present disclosure relates to light emitting diode (LED) illuminating devices and, particularly, to an LED tube lamp.

2. Description of Related Art

Compared to traditional light sources, light emitting diodes (LEDs) have many advantages, such as high luminous efficiency, low power consumption, and long service life. LED lamps are widely used in many applications to replace typical fluorescent lamps and neon tube lamps.

Many LED tube lamps include a cylindrical tube, a cover and an LED substrate. However, in order to increase the illumination, a type of LED array including a plurality of LEDs connected in series arranged on the LED substrate is used in LED tube lamps. In another way, the cover is made of transparent or translucent material mixed with light diffusion particles to improve the light scattering effect of the light. However, these improvements are not suitable for local lighting, such as in the case of a wall, showing exhibits in a gallery, which requires sufficient illumination on specific items.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an assembled, isometric view of an LED tube lamp in accordance with an exemplary embodiment.

FIG. 2 is a cross-sectional view of the LED tube lamp of FIG. 1, taken along line II-II.

FIG. 3 is a schematic, cross-sectional view showing a cover of the LED tube lamp of FIG. 1.

FIG. 4 is a schematic, cross-sectional view showing light beams passing through the cover of the LED tube lamp of FIG. 1.

FIG. 5 is an assembled, isometric view of an LED tube lamp in accordance with a second embodiment.

FIG. 6 is an assembled, isometric view of an LED tube lamp in accordance with a third embodiment.

FIG. 7 is an assembled, isometric view of an LED tube lamp in accordance with a fourth embodiment.

FIG. 8 is an assembled, isometric view of an LED tube lamp in accordance with a fifth embodiment.

FIG. 9 is an assembled, isometric view of an LED tube lamp in accordance with a sixth embodiment.

### DETAILED DESCRIPTION

Embodiments of the present disclosure will now be described in detail, with reference to the accompanying drawings.

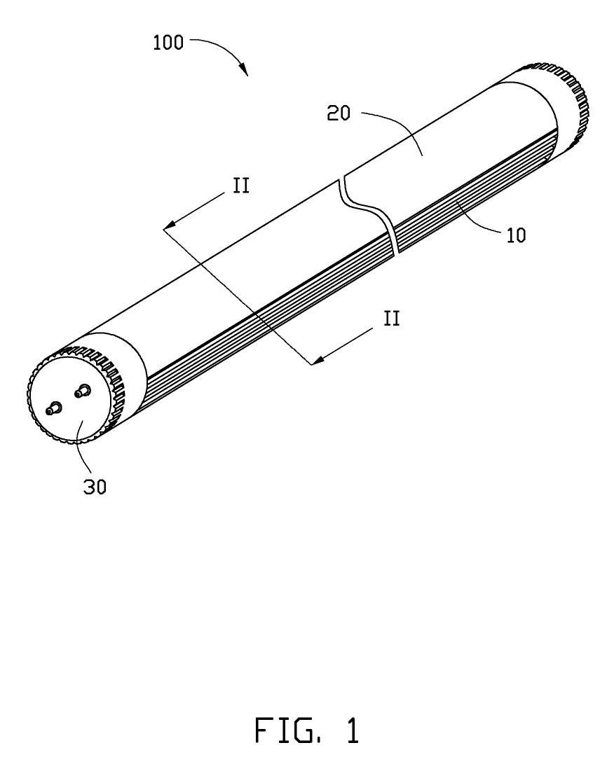

Referring to FIG. 1, a first embodiment of an LED tube lamp 100 is illustrated. The LED tube lamp 100 includes a heat sink 10, a cover 20, and a pair of connectors 30. The cover 20 is fixed to the heat sink 10. The cover has an elongated structure and has an arc-shaped cross section. The connectors 30 are arranged at opposite ends of the LED tube lamp 100 and are used to connect to a connector (not shown), thus electrically connecting the LED tube lamp 100 to a power source.

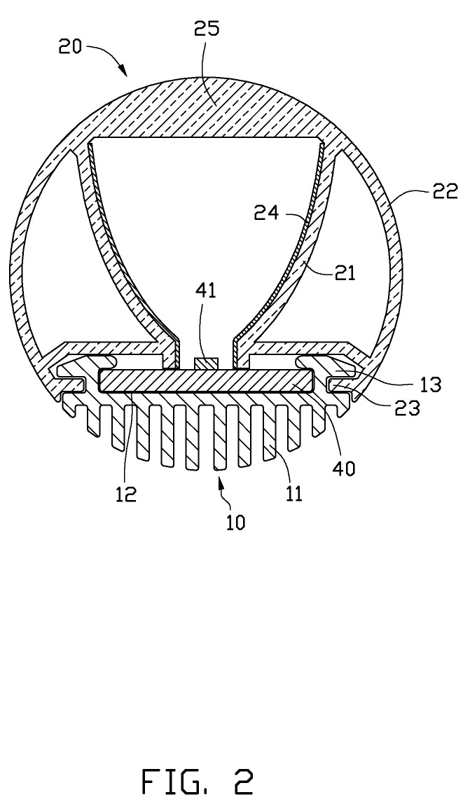

Referring to FIG. 2, the LED tube lamp 100 further includes an LED substrate 40 mounted on the heat sink 10 and electrically connected to the connector 30. A number of LEDs 41 are arranged on the LED substrate 40. The LEDs 41 can be chosen for having a large light divergence angle, high illumination, and/or can be colored according to actual requirements.

The heat sink 10 has an elongated structure and is made of metal with good heat conductivity, such as copper or aluminum. In another embodiment, the heat sink 10 can be made of ceramic. The heat sink 10 includes a number of cooling fins 11 arranged on the bottom surface of the heat sink 10 to increase the heat dissipation area. A recess 12 is defined in the top surface of the heat sink 10 for receiving the LED substrate 40. In this embodiment, a heat-conductive medium (not shown) can be arranged between the LED substrate 40 and the inner surface of the recess 12, for transferring the heat generated by the LEDs 41 from the LED substrate 40 to the cooling fins 11. In this embodiment, the heat-conductive medium can be thermal conductive glue or heat-conductive plate. In this embodiment, the LED substrate 40 is fixed on the heat sink 10 by screws (not shown).

The heat sink 10 further includes connecting portions 13. In the embodiment, the connecting portions 13 are grooves. The cover 20 includes two projecting members 24 extending inward from the opposite ends of the cover 20. The projecting members 24 are respectively received in the connecting portions 13, thus fixing the cover 20 to the heat sink 10. The cover 20 faces the LED substrate 40, the light beams emitted from the LEDs 41 pass through the cover 20.

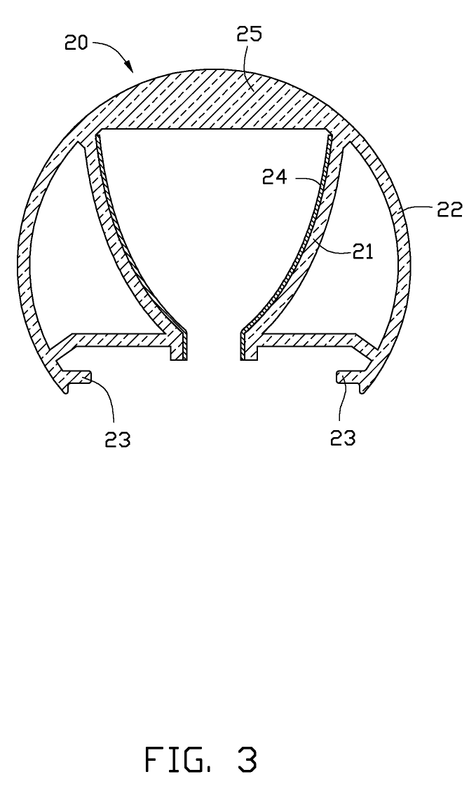

Referring to FIG. 3, the cover 20 includes a light gathering wall 21 and a cover body 22. The light gathering wall 21 is arranged between the cover body 22 and the LED substrate 40. In this embodiment, the light gathering wall 21 and the cover body 22 are integrally formed. The cover 20 can be made by integrated forming process, such as extrusion molding. The cover 20 is transparent and can be made of plastic or glass, such as polymethyl methacrylate (PMMA), polystyrene (PS), or polyethylene terephthalate (PET).

In this embodiment, the cover body 22 is arc-shaped in its cross section. The light gathering wall 21 is a parabolic reflector with a parabolic-shaped cross section. A reflective film 24 is set on the inner surface of the wall 21. The LEDs 41 are arranged adjacent to the bottom of the wall 21. The light beams emitting from the LEDs 41 are reflected and are gathered by the light gathering wall 21.

The cover body 22 includes a condenser lens 25 that faces the light gathering wall 21, and is used to gather the light beams passing therethrough. In this embodiment, the condenser lens 25 is a convex lens. Furthermore, the cover 20 is made of transparent material, and the condenser lens 25 can be formed by controlling the thickness of the cover body 22 during the manufacturing process.

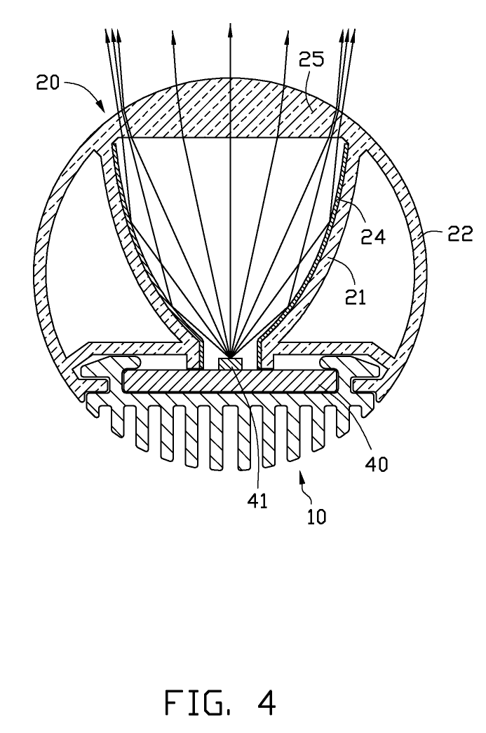

Referring to FIG. 4, the light beams emitting from the LEDs 41 are reflected and gathered by the light gathering wall 21. The light beams that emit from the light gathering wall 21 are further gathered as they pass through the condenser lens 25. The light beams emitting from the LEDs 41 can be controlled substantially in a desired illuminating range after being gathered twice. In this way, the LED tube lamp 100 can provide high brightness, directional light beams. The LED tube lamp 100 can be employed to illuminate a certain region requiring sufficient illumination, such as the case of a wall showing exhibits in hall.

In other embodiments, the light gathering wall 21 can be defined to direct appropriate direction. The light beams emitting from the LEDs 41 are reflected and are gathered by the light gathering wall 21, thus the light beams can be oriented on the light gathering wall 21.

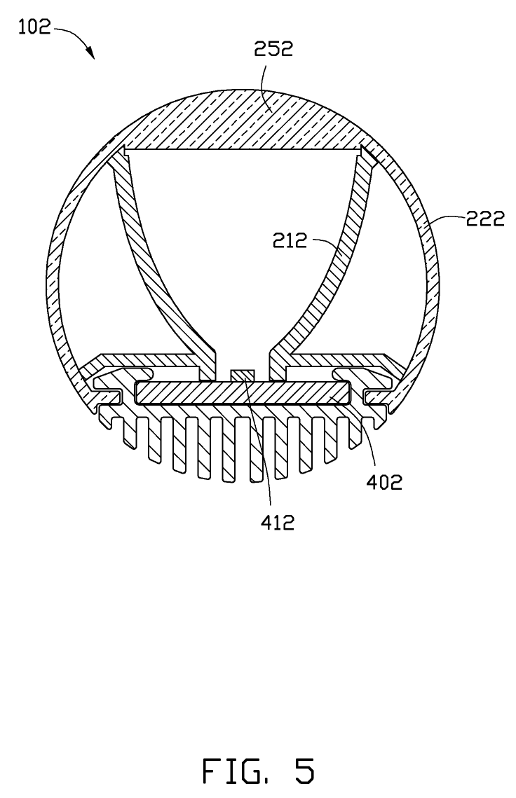

Referring to FIG. 5, an LED tube lamp 102 according a second embodiment is illustrated. The LED tube lamp 102 is similar to the LED tube lamp 100 described above. The LED tube lamp 102 includes a cover (not labeled) and an LED substrate 402 including a number of LEDs 412 arranged thereon. The cover includes a cover body 222 and a light gathering wall 212. The difference between the lamps 102 and 100 is that the cover body 222 and the light gathering wall 212 are the components are independent from each other. The light gathering wall 212 is accommodated in the cover body 222, arranged between the LED substrate 402 and the cover body 222. The light gathering wall 212 is parabolic-shaped in cross section, and the cover body 222 includes a condenser lens 252 facing the light gathering wall 212. The light beams emitting from the LEDs 412 are reflected and are gathered by the light gathering wall 212. The light beams reflected from the light gathering wall 212 are further gathered as they pass through the condenser lens 252.

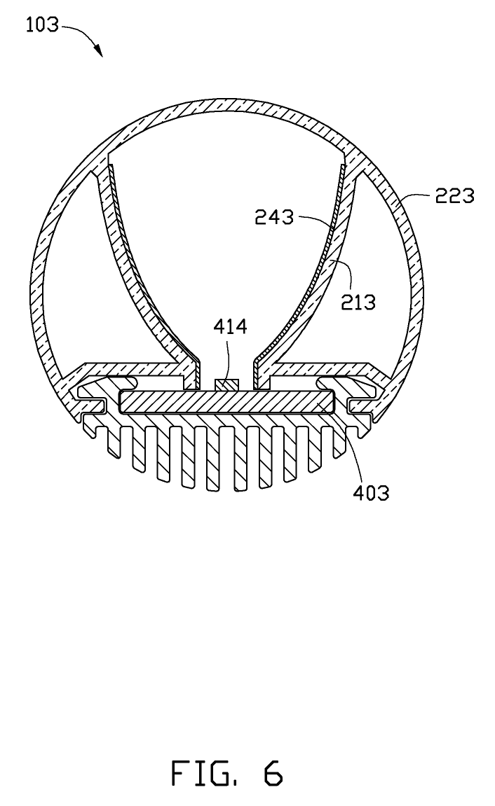

Referring to FIG. 6, an LED tube lamp 103 according a third embodiment is illustrated. The LED tube lamp 103 includes a cover (not label) and a LED substrate 403 including a number of LEDs 413 arranged on the LED substrate. The cover includes a cover body 223 and a light gathering wall 213. The difference between the lamps 103 and 100 is that the lamps 103 only employ the light gathering wall 213 to gather light. The light gathering wall 213 and the cover body 223 are integrally formed. The light gathering wall 213 is a parabolic reflector with a parabolic-shaped cross section. In this embodiment, the light gathering wall 213 is a parabolic reflector. The parabolic reflector can be defined to direct appropriate direction. The light beams exiting from the light gathering wall 213 pass through the cover 223 and spread out. The light beams can be oriented on the light gathering wall 213, and be employed to illuminate a certain region requiring sufficient illumination.

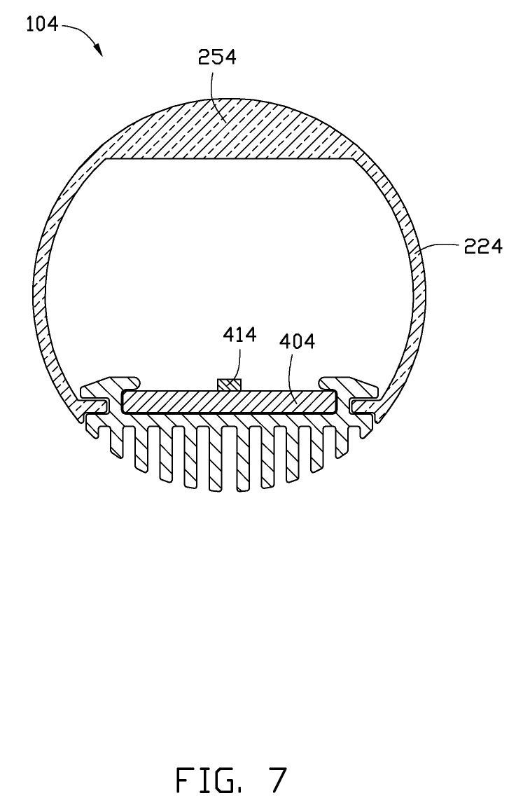

Referring to FIG. 7, an LED tube lamp 104 according a fourth embodiment is illustrated. The LED tube lamp 104 is similar to the LED tube lamp 100 described above. The LED tube lamp 103 includes a cover 224 and a LED substrate 404 including a number of LEDs 414 arranged thereon. The difference between the LED tube lamp 104 and 100 is that the lamps 104 only employ the condenser lens 254 to gather light. The cover 224 includes a condenser lens 254 facing the LEDs 414. Some of the light beams from the LEDs 414 reach the cover 224 and spread out directly, while some of the light beams from the LEDs 414 are gathered as they reach the condenser lens 254. In this embodiment, the LED tube lamp 104 can provide an omnidirectional illumination. The light beams passing through the condenser lens 254 can apply a brightly and dense light beam for illuminating a certain region requiring sufficient illumination in illuminating region of the LED tube lamp 104.

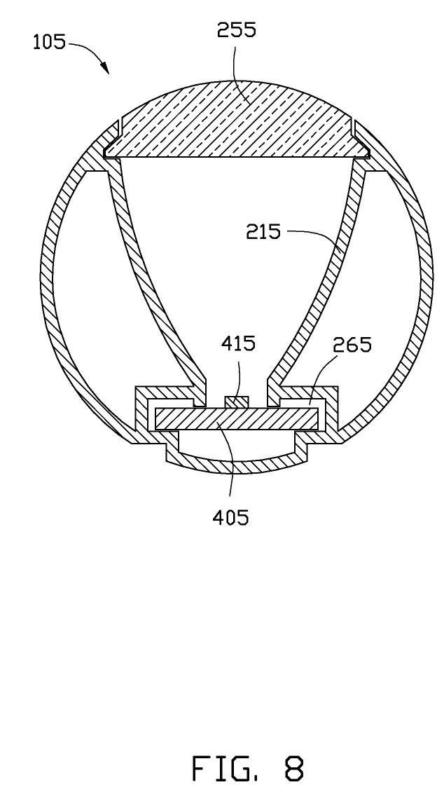

Referring to FIG. 8, an LED tube lamp 105 according to a fifth embodiment is illustrated. The LED tube lamp 105 includes a cover 205 and a LED substrate 405 including a number of LEDs 415 arranged thereon. In this embodiment, the LEDs 415 are low-power LEDs. The LED tube lamp 105 can thus work without a heat sink for the LEDs 415 has low heat-producing capability. The cover 205 includes a light gathering wall 215. The light gathering wall 215 is a parabolic reflector with parabolic-shaped cross section. A recess 265 is defined on the bottom of the parabolic reflector for receiving the LED substrate 405. The light beams emitting from the LEDs 41 is reflected and is gathered by the light gathering wall 215. A condenser lens 255 is arranged facing the light gathering wall 215, and is clasped or glued with the light gathering wall 215 to fasten the cover 205 and the condenser lens 255 together. The light beams reflected from the light gathering wall 215 are further gathered as they pass through the condenser lens 255.

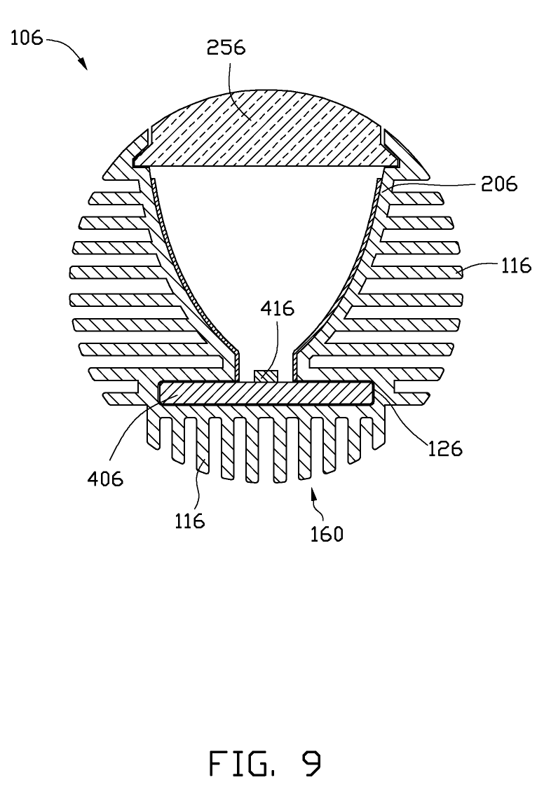

Referring to FIG. 9, an LED tube lamp 106 according to a sixth embodiment is illustrated. The LED tube lamp 106 includes a heat sink 160 and a LED substrate 406 including a number of LEDs 416 arranged thereon. In this embodiment, the LEDs 416 are high-power LEDs. The requirement for the heat dissipation efficiency of heat sink 160 is strict in LED tube lamp 106 due to the LEDs 416 having high heat-producing capability. The heat sink 160 includes a number of cooling fins 116 arranged on the bottom surface of the heat sink 160, and a recess 126 arranged opposite to the cooling fins 116 for receiving the LED substrate 406. The heat sink 160 further includes a light gathering wall 206. The light gathering wall 206 is a parabolic reflector with a parabolic-shaped cross section. The LEDs 416 are arranged adjacent to the bottom of the parabolic reflector. A reflective film (not labeled) is applied on the inner surface of the parabolic reflector, and a number of cooling fins 116 arranged on the outer surface of the parabolic reflector. The light beams emitting from the LEDs 416 are reflected and are gathered by the light gathering wall 216. A condenser lens 256 is arranged facing the light gathering wall 216. The condenser lens 256 is clasped or is glued with the light gathering wall 216 to fasten the cover 206 and the condenser lens 256 together. The light beams reflected from the light gathering wall 216 are further gathered as they pass through the condenser lens 256.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An LED tube lamp, comprising:
a heat sink;
an LED substrate mounted on the heat sink and comprising a plurality of LEDs; and
a cover fixed to the heat sink, and shielding the plurality of LEDs;
a light gathering wall arranged between the cover and the LED substrate;
wherein the LEDs are arranged adjacent to a bottom of the light gathering wall, the cover further comprises a condenser lens, the light gathering wall is configured for reflecting and gathering the light beams emitting form the LEDs, the condenser lens is configured for further gathering the light beams reflected from the light gathering wall.

2. The LED tube lamp according to claim 1, wherein the light gathering wall is a parabolic reflector with a parabolic-shaped cross section.

3. The LED tube lamp according to claim 1, wherein the light gathering wall and the cover are integrally formed.

4. The LED tube lamp according to claim 1, wherein a reflective film is arranged on an inner surface of the light gathering wall.

5. The LED tube lamp according to claim 1, wherein the condenser lens is a convex lens.

6. The LED tube lamp according to claim 1, wherein the cover is made of transparent material.

7. The LED tube lamp according to claim 1, wherein the heat sink defines two grooves, the cover comprises two projecting members extending inwardly from the opposite ends of the cover, the two projecting members are respectively received in the grooves.

8. The LED tube lamp according to claim 1, where a recess is defined in the top surface of the heat sink for receiving the LED substrate.

9. The LED tube lamp according to claim 1, wherein a plurality of cooling fins are arranged on the bottom surface of the heat sink.

10. An LED tube lamp, comprising:
a heat sink;
an LED substrate mounted on the heat sink and comprising a plurality of LEDs; and
a cover fixed to the heat sink, and shielding the plurality of LEDs;
a light gathering wall arranged between the cover and the LED substrate;
wherein the LEDs are arranged adjacent to a bottom of the light gathering wall, the light gathering wall is configured for reflecting and gathering the light beams emitting form the LEDs, thus to orient the light beams.

11. The LED tube lamp according to claim 10, wherein the light gathering wall is a parabolic reflector with a parabolic-shaped cross section.

12. The LED tube lamp according to claim 10, wherein the light gathering member and the cover are integrally formed.

13. The LED tube lamp according to claim 10, wherein a reflective film is arranged on an inner surface of the light gathering wall.

14. An LED tube lamp, comprising:
a heat sink;
an LED substrate mounted on the heat sink and comprising a plurality of LEDs; and
a cover fixed to the heat sink, and shielding the plurality of LEDs;
wherein the cover further comprises a condenser lens facing the plurality of LEDs and configured for gathering the light beams travelling to the condenser lens.

15. The LED tube lamp according to claim 14, wherein the condenser lens is a convex lens.

16. The LED tube lamp according to claim 14, wherein the cover is made of transparent material.
